(19) United States
(12) Patent Application Publication
(10) Pub. No.: US 2026/0112666 A1
(43) Pub. Date: Apr. 23, 2026

(54) FUEL CELL SYSTEM

(71) Applicant: AISAN KOGYO KABUSHIKI KAISHA, Obu-shi (JP)

(72) Inventor: Daisaku ASANUMA, Gamagori-shi (JP)

(73) Assignee: AISAN KOGYO KABUSHIKI KAISHA, Obu-shi (JP)

(21) Appl. No.: 19/350,563

(22) Filed: Oct. 6, 2025

(30) Foreign Application Priority Data
Oct. 21, 2024 (JP) 2024-184786

(51) Int. Cl. H01M 8/04701; G01K 1/02; G01K 3/00; G01L 19/00; H01M 8/04007; H01M 8/04082; H01M 8/04089; H01M 8/0432; H01M 8/0438; H01M 8/04746

(52) U.S. Cl. CPC H01M 8/04731; G01K 1/026; G01K 3/005; G01L 19/0092; H01M 8/04007; H01M 8/04089; H01M 8/04216; H01M 8/04365; H01M 8/04388; H01M 8/04761

(57) ABSTRACT

A fuel cell system in one aspect of the disclosure includes a first pressure sensor for measuring the pressure in a hydrogen gas supply passage between a hydrogen absorbing alloy canister and an injector, and a control unit configured to control an exhaust-drain valve. When a measured value of the first pressure sensor is equal to or less than a predetermined pressure, the control unit controls the exhaust-drain valve to increase the number of opening-closing operations per unit time more than when the measured value of the first pressure sensor is higher than the predetermined pressure.

### CROSS-REFERENCE TO RELATED APPLICATIONS

This application is based upon and claims the benefit of priority to Japanese Patent Application No. 2024-184786 filed on Oct. 21, 2024, the entire contents of which are incorporated herein by reference.

### BACKGROUND

### Technical Field

The disclosure relates to a fuel cell system having a fuel cell that generates electricity, or electric power, by receiving supply of fuel gas and oxidant gas.

### Related Art

Japanese unexamined patent application publication No. 2002-184418 (JP2002-184418A) discloses a fuel cell system configured to cause a fuel cell to generate power by supplying hydrogen gas released from a hydrogen absorbing alloy canister (i.e., hydrogen absorbing alloy) to the fuel cell.

### SUMMARY

### Technical Problems

In the fuel cell system disclosed in JP2002-184418A, when the temperature of the hydrogen absorbing alloy canister is low, the discharge pressure of hydrogen gas from the hydrogen absorbing alloy canister, i.e., the pressure of hydrogen gas released from the hydrogen absorbing alloy canister, decreases, resulting in a reduced amount of hydrogen gas supplied to the fuel cell. Thus, the fuel cell may not secure the concentration of hydrogen gas required for power generation.

The disclosure has been made to address the above problems and has a purpose to provide a fuel cell system capable of stably securing hydrogen gas at a concentration required for power generation in a fuel cell.

### Means of Solving the Problems

To achieve the above-mentioned purpose, one aspect of the present disclosure provides a fuel cell system including: a fuel cell; a hydrogen gas supply passage for supplying hydrogen gas to the fuel cell; a hydrogen storage container filled with hydrogen absorbing alloy and configured to release the hydrogen gas to the hydrogen gas supply passage; a hydrogen gas supply device placed in the hydrogen gas supply passage and configured to supply the hydrogen gas released from the hydrogen storage container to the fuel cell; a hydrogen off-gas exhaust passage for exhausting hydrogen off-gas exhausted from the fuel cell to outside of the fuel cell system; and an exhaust control valve placed in the hydrogen off-gas exhaust passage and configured to control exhaust of the hydrogen off-gas to the outside, wherein the fuel cell system further includes: at least one of a pressure measuring unit for measuring a pressure in the hydrogen gas supply passage between the hydrogen storage container and the hydrogen supply device and a container temperature measuring unit for measuring a temperature of the hydrogen storage container; and a control unit configured to control the exhaust control valve, wherein when a measured value of the pressure measuring unit is equal to or less than a predetermined pressure, the control unit controls the exhaust control valve to increase the number of opening-closing operations per unit time more than when the measured value of the pressure measuring unit is higher than the predetermined pressure, and/or when a measured value of the container temperature measuring unit is equal to or less than a predetermined container temperature, the control unit controls the exhaust control valve to increase the number of opening-closing operations per unit time more than when the measured value of the container temperature measuring unit is higher than the predetermined container temperature.

According to the above configuration, when the temperature of the hydrogen storage container decreases, and the discharge pressure of hydrogen gas from the hydrogen storage container decreases, decreasing the pressure in the hydrogen gas supply passage between the hydrogen storage container and the hydrogen supply device, the number of opening-closing operations of the exhaust control valve per unit time is increased. This configuration enhances the exhaust efficiency of nitrogen and water generated by power generation in the fuel cell, and accordingly increase the concentration of hydrogen gas in the fuel cell. Therefore, it is possible to stably secure the required hydrogen gas concentration for power generation in the fuel cell.

Furthermore, the power generation in the fuel cell is promoted and thus the fuel cell generates heat, so that the heat generated in the fuel cell can be transferred to the hydrogen storage container. Accordingly, the hydrogen storage container is warmed, increasing the discharge pressure of hydrogen gas from the hydrogen storage container, and raising the pressure in the hydrogen gas supply passage between the hydrogen storage container and the hydrogen supply device. Consequently, the amount of hydrogen gas supplied to the fuel cell increases, stably securing the required hydrogen gas concentration for power generation in the fuel cell.

In the above-described configuration, the control unit may control the exhaust control valve to increase the number of opening-closing operations by shortening a valve-closing time of the exhaust control valve.

According to this configuration, to increase the number of opening-closing operations of the exhaust control valve, the valve-closing time of the exhaust control valve is shortened. This can suppress exhaust of the hydrogen gas from the fuel cell, and thus the concentration of hydrogen gas in the fuel cell can be increased.

The above-described configuration may further includes: a fan for blowing heat generated in the fuel cell toward the hydrogen storage container; and a cell temperature measuring unit for measuring a temperature of the fuel cell. The control unit may be further configured to control the fan, and the control unit activates the fan when a measured value of the cell temperature measuring unit is equal to or higher than a predetermined cell temperature, and the control unit stops the fan when the measured value of the cell temperature measuring unit is less than the predetermined cell temperature.

According to this configuration, when the fuel cell is warmed up and its temperature becomes high, the fan is activated to transfer the heat generated in the fuel cell to the hydrogen storage container. This can increase the efficiency of releasing hydrogen gas from the hydrogen storage container. Consequently, the amount of hydrogen gas supplied from the hydrogen storage container to the fuel cell can be increased.

In contrast, when the fuel cell is not warmed up and its temperature is low, the fan is stopped so as not to blow cold air to the hydrogen storage container. This can suppress a decrease in the release efficiency of hydrogen gas from the hydrogen storage container. It is therefore possible to suppress a decrease in the amount of hydrogen gas to be supplied from the hydrogen storage container to the fuel cell.

The fuel cell system of the disclosure can stably secure the required hydrogen gas concentration for power generation in a fuel cell.

### BRIEF DESCRIPTION OF THE DRAWINGS

FIG. 1 is a configuration diagram of a fuel cell system (an open cathode type system) in an embodiment;

FIG. 2 is a characteristic diagram of temperature, hydrogen pressure, and hydrogen concentration of a hydrogen absorbing alloy canister;

FIG. 3 is a diagram showing that an FC stack, the hydrogen absorbing alloy canister, and a battery are placed in a case;

FIG. 4 is a flowchart showing control contents, which are executed in the embodiment; and

FIG. 5 is a configuration diagram of a fuel cell system (a closed cathode type system) in a modified example.

DETAILED DESCRIPTION OF THE EXEMPLARY EMBODIMENTS

A detailed description of an embodiment of a fuel cell system of the disclosure will now be given referring to the accompanying drawings.

### Configuration of Fuel Cell System

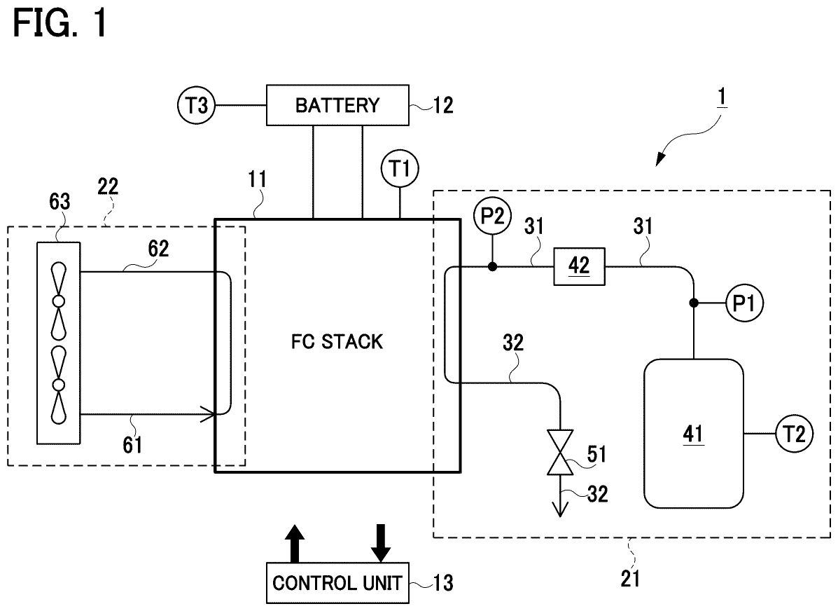

As shown in FIG. 1, a fuel cell system 1 in the present embodiment includes a FC stack 11 (an air-cooled FC stack), a battery 12 (a secondary battery), a hydrogen-related system 21, and an air-related and cooling-related system 22. The FC stack 11 is one example of a fuel cell of the disclosure.

The FC stack 11 generates electric power by receiving supply of fuel gas and oxidant gas. In the present embodiment, the fuel gas is hydrogen gas, and the oxidant gas is air, i.e., atmospheric air. Specifically, the FC stack 11 generates electricity by receiving the hydrogen gas supplied from the hydrogen-related system 21 and the air supplied from the air-related and cooling-related system 22. The electric power generated in the FC stack 11 is supplied to the battery 12, and an inverter and a motor (not shown).

The battery 12 is connected to the FC stack 11 and charged with the electric power generated by the FC stack 11. This battery 12 supplies the electric power to the inverter and the motor (not shown).

The hydrogen-related system 21 is provided on the anode side of the FC stack 11. This hydrogen-related system 21 includes a hydrogen gas supply passage 31 and a hydrogen off-gas exhaust passage 32.

The hydrogen gas supply passage 31 is a passage for supplying hydrogen gas from a hydrogen absorbing alloy canister 41, in which the hydrogen gas is stored, to the FC stack 11. The hydrogen off-gas exhaust passage 32 is a passage for exhausting the hydrogen gas, i.e., hydrogen off-gas, exhausted from the FC stack 11.

Further, the hydrogen-related system 21 includes the hydrogen absorbing alloy canister 41 in the hydrogen gas supply passage 31, as shown in FIG. 1, and further includes a first pressure sensor P1, an injector 42, and a second pressure sensor P2, which are arranged in this order from the hydrogen absorbing alloy canister 41.

The hydrogen absorbing alloy canister 41 is one example of a hydrogen storage container of the disclosure. The first pressure sensor P1 is one example of a pressure measuring unit of the disclosure. The injector 42 is one example of a hydrogen supply device of the disclosure.

The hydrogen absorbing alloy canister 41 is a container filled with hydrogen absorbing alloy, which has the property of absorbing and releasing hydrogen gas. In other words, the hydrogen absorbing alloy canister 41 is filled with hydrogen absorbing alloy and can release hydrogen gas to the hydrogen gas supply passage 31 and absorb hydrogen gas from a hydrogen tank not shown.

The first pressure sensor P1 measures the pressure in the hydrogen gas supply passage 31 between the hydrogen absorbing alloy canister 41 and the injector 42, that is, the discharge pressure of the hydrogen absorbing alloy canister 41. the injector 42 is a device that supplies hydrogen gas released from the hydrogen absorbing alloy canister 41 by injecting this gas into the FC stack 11 located on a downstream side. The second pressure sensor P2 measures the outlet pressure of the injector 42, i.e., the injection pressure of the injector 42.

The hydrogen-related system 21 includes an exhaust-drain valve 51 placed in the hydrogen off-gas exhaust passage 32 to control switching between exhaust and shut-off of hydrogen off-gas and water to the outside. The exhaust-drain valve 51 is one example of an exhaust control valve of the disclosure.

On the other hand, the air-related and cooling-related system 22 is provided on the cathode side of the FC stack 11. This air-related and cooling-related system 22 is provided with an air supply passage 61, an air off-gas exhaust passage 62, and a fan 63.

The air supply passage 61 is a passage for supplying air from the outside of the fuel cell system 1 to the FC stack 11. The air off-gas exhaust passage 62 is a passage for exhausting air discharged from the FC stack 11, i.e., air off-gas.

The fan 63 supplies air to the FC stack 11 via the air supply passage 61 and also exhausts air off-gas from the FC stack 11 via the air off-gas exhaust passage 62.

In the present embodiment, the fan 63 serves not only to supply air to the FC stack 11 via the air supply passage 61 to cause the FC stack 11 to generate electric power using the air, but also to cool the FC stack 11. The fuel cell system 1 shown in FIG. 1 is thus an open cathode type system that uses the air supplied to the FC stack 11 by the fan 63 as a gas for cooling the FC stack 11.

The fuel cell system 1 includes a first temperature sensor T1, a second temperature sensor T2, and a third temperature sensor T3. The first temperature sensor T1 measures the temperature of the FC stack 11. The second temperature sensor T2 measures the temperature of the hydrogen absorbing alloy canister 41. The third temperature sensor T3 measures the temperature of the battery 12. The first temperature sensor T1 is one example of a battery temperature measuring unit of the disclosure. The second temperature sensor T2 is one example of a container temperature measuring unit of the disclosure.

Furthermore, the fuel cell system 1 includes a control unit 13. This control unit 13 is a device including, for example, a processing unit, such as a CPU, a memory unit, such as a ROM for storing control programs and control data processed by the CPU, a RAM used as various working areas for control processing, and an input/output interface unit. The control unit 13 executes various controls of the fuel cell system 1 in accordance with the control programs stored in the memory unit.

In the present embodiment, the control unit 13 performs various controls of the fuel cell system 1 to control the injector 42, the exhaust-drain valve 51, the fan 63, a cooling fan 71 mentioned later, and others. The control unit 13 obtains a measured value of the discharge pressure of the hydrogen absorbing alloy canister 41 from the first pressure sensor P1 and a measured value of the outlet pressure of the injector 42 from the second pressure sensor P2. The control unit 13 further obtains a measured value of the temperature of the FC stack 11 from the first temperature sensor T1, a measured value of the temperature of the hydrogen absorbing alloy canister 41 from the second temperature sensor T2, and a measured value of the temperature of the battery 12 from the third temperature sensor T3.

### Operations of Fuel Cell System

In the fuel cell system 1 configured as above, the hydrogen gas supplied to the FC stack 11 via the hydrogen gas supply passage 31 is used for power generation in the FC stack 11, and then exhausted as hydrogen off-gas from the FC stack 11 to the outside of the fuel cell system 1 via the hydrogen off-gas exhaust passage 32. Furthermore, the air supplied to the FC stack 11 via the air supply passage 61 is used for power generation in the FC stack 11, and then exhausted as air off-gas from the FC stack 11 to the outside of the fuel cell system 1 via the air off-gas exhaust passage 62.

The electric power generated in the FC stack 11 is charged to the battery 12 and supplied to the inverter and the motor not shown.

The measures for securing a hydrogen gas concentration required for power generation in FC stack will be described below.

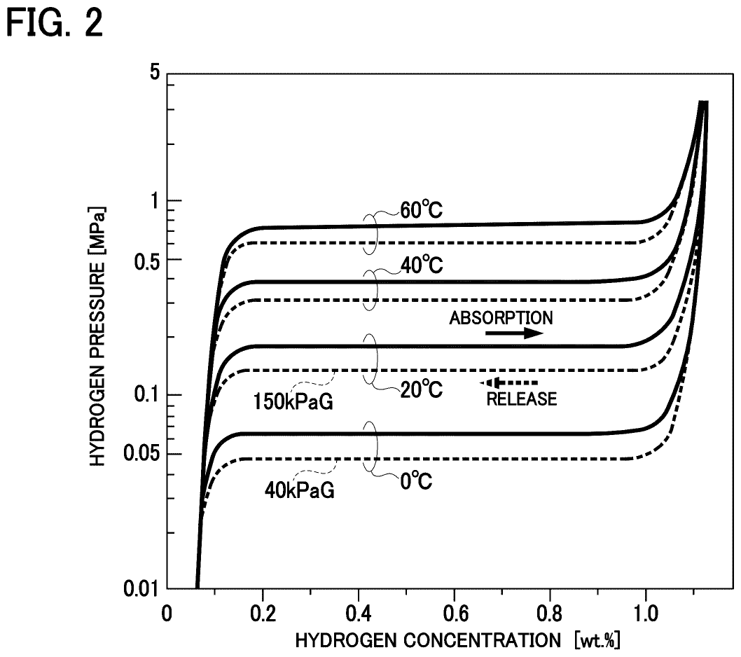

The hydrogen absorbing alloy canister 41 changes the discharge pressure of hydrogen gas, i.e., the pressure of hydrogen gas released from the hydrogen absorbing alloy canister 41, depending on its own temperature. As shown in FIG. 2, the discharge pressure of hydrogen gas (labeled “HYDROGEN PRESSURE” in the figure) of the hydrogen absorbing alloy canister 41 decreases as its temperature (indicated in the figure as 0° C., 20° C., 40° C., and 60°C.) is lower. For example, when the temperature of the hydrogen absorbing alloy canister 41 is 20° C. or less, the discharge pressure of hydrogen gas decreases to a range of 40 kPaG to 150 kPaG. Then, when the discharge pressure of hydrogen gas of the hydrogen absorbing alloy canister 41 lowers, the amount of hydrogen gas supplied to the FC stack 11 decreases, which may result in the possibility that the hydrogen gas cannot be secured at a concentration required for power generation in the FC stack 11.

In the present embodiment, therefore, the following measures are implemented to stably secure the required concentration of hydrogen gas for power generation in the FC stack 11, regardless of the temperature of the hydrogen absorbing alloy canister 41. Specifically, when the temperature of the hydrogen absorbing alloy canister 41 is low and thus the discharge pressure of hydrogen gas of the hydrogen absorbing alloy canister 41 is low, the hydrogen absorbing alloy canister 41 is warmed up by use of the heat generated when the FC stack 11 becomes the warm-up state, to increase the temperature of the hydrogen absorbing alloy canister 41, thereby raising the discharge pressure of hydrogen gas of the hydrogen absorbing alloy canister 41. This increases the amount of hydrogen gas to be supplied to the FC stack 11 so as to ensure that hydrogen gas in the FC stack 11 has a necessary concentration for generate power.

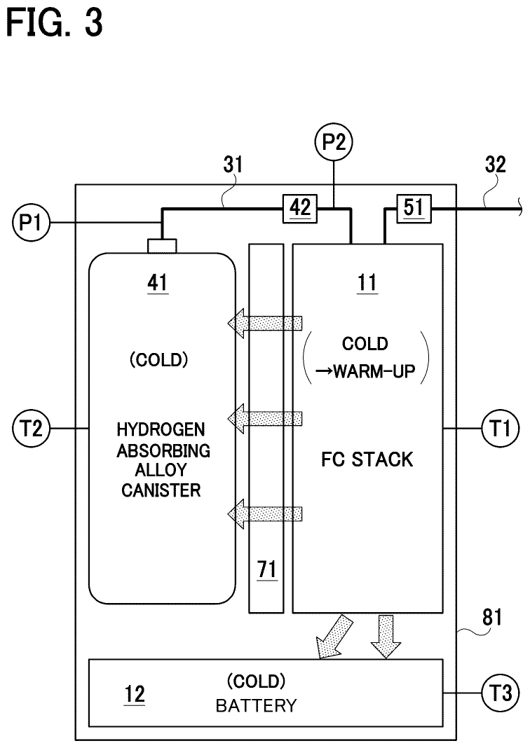

To be more specific, as shown in FIG. 3, in the present embodiment, the FC stack 11, the hydrogen absorbing alloy canister 41, and the battery 12 are placed in a case 81 having such a shape as to enclose those components, thus forming a module. The cooling fan 71 is provided near the FC stack 11 in advance, and the hydrogen absorbing alloy canister 41 is disposed facing the FC stack 11 via the cooling fan 71. The cooling fan 71 is one example of a fan of the disclosure.

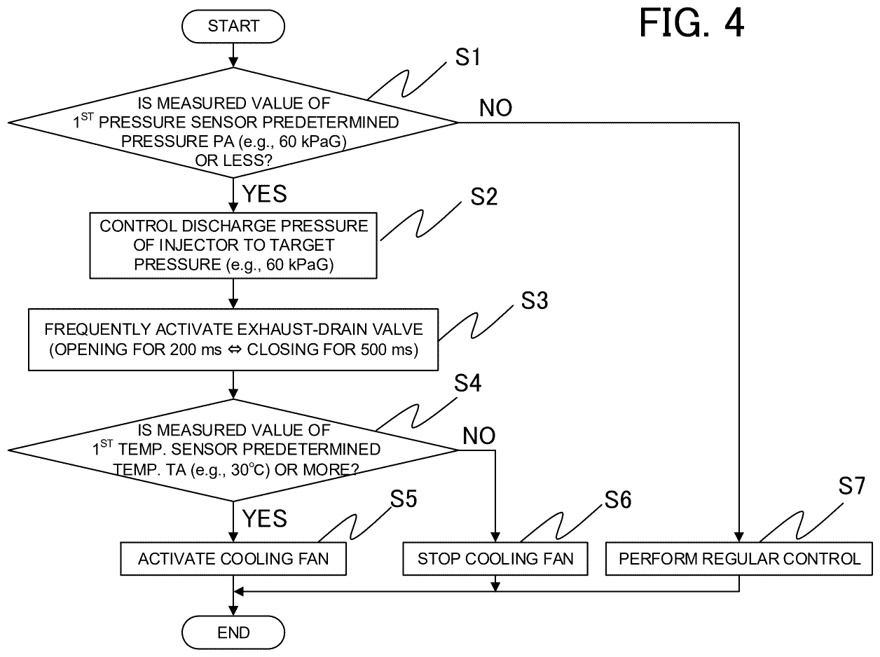

The control unit 13 performs the control contents shown in FIG. 4. As shown in FIG. 4, the control unit 13 determines whether or not a measured value of the first pressure sensor P1, i.e., a measured value of the discharge pressure of hydrogen gas from the hydrogen absorbing alloy canister 41, is equal to or less than a predetermined pressure PA (e.g., 60 kPaG) (step S1).

When the measured value of the first pressure sensor P1 is the predetermined pressure PA or less (step S1: YES), the control unit 13 first controls the outlet pressure of the injector 42 to a target pressure (e.g., 60 kPaG) (step S2).

The control unit 13 then activates the exhaust-drain valve 51 frequently in an operation of e.g., “opening for 200 milliseconds (ms)←→closing for 500 milliseconds (ms)” (step S3). This operation “opening for 200 ms←→closing for 500 ms” means that repeating the cycle of maintaining a valve-open state for 200 ms and then maintaining a valve-closed state for 500 ms.

In the above manner, when the measured value of the first pressure sensor P1 is the predetermined pressure PA or less and the discharge pressure of hydrogen gas from the hydrogen absorbing alloy canister 41 is low, the control unit 13 activates the exhaust-drain valve 51 frequently while controlling the discharge pressure of the injector 42 to the target pressure, thereby increasing the number of opening-closing operations of the exhaust-drain valve 51 per unit time more than when the measured value of the first pressure sensor P1 is higher than the predetermined pressure PA.

At that time, the control unit 13 controls the exhaust-drain valve 51 to increase the number of opening-closing operations per unit time by shortening the valve-closing time of the exhaust-drain valve 51 compared to when performing the normal control in step S7 mentioned below. This can enhance the efficiency of exhausting nitrogen and water generated by power generation in the FC stack 11 (via the exhaust-drain valve 51), thereby increasing the concentration of hydrogen gas in the FC stack 11.

In a modified example, when the measured value of the second temperature sensor T2 is equal to or less than a predetermined temperature TB (e.g., 10° C.), the control unit 13 controls the exhaust-drain valve 51 to increase the number of opening-closing operations per unit time more than when the measured value of the second temperature sensor T2 is higher than the predetermined temperature TB. Here, the predetermined temperature TB is one example of a predetermined container temperature of the disclosure.

Subsequently, the control unit 13 determines whether or not the measured value of the first temperature sensor T1 is equal to or higher than a predetermined temperature TA (e.g., 30°C.) (step S4). The predetermined temperature TA is one example of a predetermined battery temperature of the disclosure.

When the measured value of the first temperature sensor T1 is the predetermined temperature TA or higher (step S4: YES), the control unit 13 activates the cooling fan 71 (step S5).

In this way, when the temperature of the FC stack 11 is high such that the measured value of the first temperature sensor T1 is the predetermined temperature TA or higher, the cooling fan 71 is activated. Thus, the heat generated in the FC stack 11 when warmed up is blown toward the hydrogen absorbing alloy canister 41 by the cooling fan 71. Accordingly, the hydrogen absorbing alloy canister 41 can be warmed by the heat generated in the warmed-up FC stack 11. This can increase the discharge pressure of hydrogen gas from the hydrogen absorbing alloy canister 41.

In the present embodiment, since the FC stack 11, the hydrogen absorbing alloy canister 41, and the battery 12 are placed in the case 81, when the heat generated in the FC stack 11 in a warmed-up state raises the internal temperature of the case 81, the hydrogen absorbing alloy canister 41 and the battery 12 are simultaneously warmed up.

On the other hand, when the measured value of the first temperature sensor T1 is less than the predetermined temperature TA (step S4: NO), the control unit 13 stops the cooling fan 71 (step S6).

In this way, when the temperature of the FC stack 11 is low such that the measured value of the first temperature sensor T1 is less than the predetermined temperature TA, the cooling fan 71 is stopped. This can suppress the hydrogen absorbing alloy canister 41 from being cooled by the air blown by the cooling fan 71.

When the measured value of the predetermined pressure PA is larger than the predetermined pressure PA (step S1: NO), the control unit 13 performs the normal control (step S7).

In this way, when the hydrogen gas discharge pressure of the hydrogen absorbing alloy canister 41 is high, the control unit 13 performs the normal control in which the outlet pressure of the injector 42 is controlled to the target pressure (e.g., 60 kPaG), and the exhaust-drain valve 51 repeats the cycle of maintaining the valve-open state for 200 ms and then maintaining the valve-closed state for 10 sec, the cooling fan 71 is controlled according to the SOC (i.e., state of charge) of the battery 12, and execution of power generation (uncontrolled power generation) and stop of power generation (intermittent stop) are carried out.

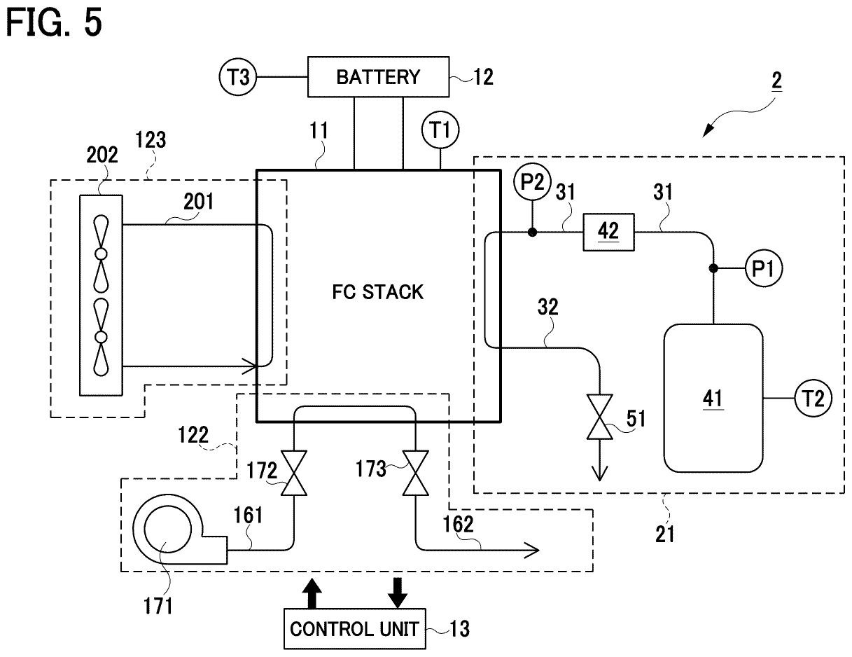

The present embodiment can also be applied to a fuel cell system 2 shown as a modified example in FIG. 5. This fuel cell system 2 is a closed cathode type system, and includes an air-related system 122 and a cooling-related system 123 as shown in FIG. 5.

The air-related system 122 is provided on the cathode side of the FC stack 11. This air-related system 122 is provided with an air supply passage 161 and an air off-gas exhaust passage 162.

The air supply passage 161 is a passage for supplying air from the outside of the fuel cell system 2 to the FC stack 11. The air off-gas exhaust passage 162 is a passage for exhausting air off-gas that has not been used in the power generation from the FC stack 11.

The air-related system 122 is provided with an air compressor 171 and an inlet air valve 172 in the air supply passage 161. The air compressor 171 is a device for supplying air to the FC stack 11. The inlet air valve 172 is located at a position downstream of the flow of air relative to the air compressor 171 and used as a valve for controlling a flow rate of air to be supplied to the FC stack 11.

The air-related system 122 is provided with an outlet air valve 173 in the air off-gas exhaust passage 162. The outlet air valve 173 is a valve for controlling the flow rate of air off-gas exhausted from the FC stack 11 to the air off-gas exhaust passage 162.

The cooling-related system 123 is a system for cooling the FC stack 11 and includes a cooling water passage 201 and a cooling fan 202. The cooling water passage 201 is a passage through which cooling water flows. The cooling fan 202 is a device for cooling the cooling water flowing through the cooling water passage 201.

In the above-described fuel cell system 2, the control unit 13 controls the air compressor 171, the inlet air valve 172, the outlet air valve 173, and the cooling fan 202.

In the fuel cell system 2 configured as above, in the air-related system 122, air supplied to the FC stack 11 via the air supply passage 161 is used for power generation in the FC stack 11, and then discharged as air off-gas out of the FC stack 11 via the air off-gas exhaust passage 162.

### Operations and Effects of Embodiment

According to the present embodiment, as described above, when the measured value of the first pressure sensor P1 is equal to or less than the predetermined pressure PA, the control unit 13 controls the exhaust-drain valve 51 to increase the number of opening-closing operations per unit time more than when the measured value of the first pressure sensor P1 is higher than the predetermined pressure PA.

When the temperature of the hydrogen absorbing alloy canister 41 decreases, the discharge pressure of hydrogen gas lowers, and thus the pressure in the hydrogen gas supply passage 31 between the hydrogen absorbing alloy canister 41 and the injector 42 decreases, the exhaust-drain valve 51 is controlled to increase the number of opening-closing operations of per unit time in the above manner. This can enhance the efficiency of exhausting nitrogen and water generated by power generation in the FC stack 11 (via the exhaust-drain valve 51), thereby increasing the concentration of hydrogen gas in the FC stack 11. Therefore, the required concentration of hydrogen gas for power generation in the FC stack 11 can be stably secured.

In addition, the power generation of the FC stack 11 is promoted and thus the FC stack 11 generates heat, so that the heat generated in the FC stack 11 can be transferred to the hydrogen absorbing alloy canister 41. When the hydrogen absorbing alloy canister 41 is warmed up by the transferred heat, the hydrogen gas discharge pressure of the hydrogen absorbing alloy canister 41 increases, thereby raising the pressure in the hydrogen gas supply passage 31 between the hydrogen absorbing alloy canister 41 and the injector 42. Accordingly, the supply amount of hydrogen gas to the FC stack 11 increases, stably providing the hydrogen gas at the required concentration for power generation in the FC stack 11.

The control unit 13 controls the exhaust-drain valve 51 to increase the number of opening-closing operations by shortening the valve-closing time of the exhaust-drain valve 51.

To increase the number of opening-closing operations of the exhaust-drain valve 51 as above, the valve-closing time of the exhaust-drain valve 51 is shortened, rather than the valve-opening time. This suppresses exhaust of hydrogen gas from the FC stack 11, and thus the concentration of hydrogen gas in the FC stack 11 is increased.

Further, the control unit 13 activates the cooling fan 71 when the measured value of the first temperature sensor T1 is equal to or higher than the predetermined temperature TA. In contrast, the control unit 13 stops the cooling fan 71 when the measured value of the first temperature sensor T1 is less than the predetermined temperature TA.

When the FC stack 11 is warmed up and its temperature is high, the cooling fan 71 is activated as above to transfer the heat generated in the FC stack 11 to the hydrogen absorbing alloy canister 41. Accordingly, the hydrogen absorbing alloy canister 41 is warmed up and its temperature rises. This increases the efficiency of releasing the hydrogen gas from the hydrogen absorbing alloy canister 41. For this reason, the amount of hydrogen gas supplied from the hydrogen absorbing alloy canister 41 to the FC stack 11 can be increased.

On the other hand, when the FC stack 11 is not warmed up and its temperature is low, the cooling fan 71 is stopped so as not to blow cold air to the hydrogen absorbing alloy canister 41. Since the hydrogen absorbing alloy canister 41 is not cooled, it is therefore possible to suppress a decrease in the efficiency of releasing the hydrogen gas from the hydrogen absorbing alloy canister 41. For this reason, the amount of hydrogen gas supplied from the hydrogen absorbing alloy canister 41 to the FC stack 11 can be suppressed from decreasing.

The foregoing embodiments are mere examples and give no limitation to the present disclosure. The present disclosure may be embodied in other specific forms without departing from the essential characteristics thereof.

### Reference Signs List

1, 2 Fuel cell system
11 FC stack
12 Battery
13 Control unit
21 Hydrogen-related system
31 Hydrogen gas supply passage
32 Hydrogen off-gas exhaust passage
41 Hydrogen absorbing alloy canister
42 Injector
51 Exhaust-drain valve
71 Cooling fan
81 Case
P1 First pressure sensor
P2 Second pressure sensor
T1 First temperature sensor
T2 Second temperature sensor
TA Predetermined temperature
TB Predetermined temperature

What is claimed is:

1. A fuel cell system comprising:
a fuel cell;
a hydrogen gas supply passage for supplying hydrogen gas to the fuel cell;
a hydrogen storage container filled with hydrogen absorbing alloy and configured to release the hydrogen gas to the hydrogen gas supply passage;
a hydrogen gas supply device placed in the hydrogen gas supply passage and configured to supply the hydrogen gas released from the hydrogen storage container to the fuel cell;
a hydrogen off-gas exhaust passage for exhausting hydrogen off-gas exhausted from the fuel cell to outside of the fuel cell system; and
an exhaust control valve placed in the hydrogen off-gas exhaust passage and configured to control exhaust of the hydrogen off-gas to the outside,
wherein the fuel cell system further comprises:
at least one of a pressure measuring unit for measuring a pressure in the hydrogen gas supply passage between the hydrogen storage container and the hydrogen supply device and a container temperature measuring unit for measuring a temperature of the hydrogen storage container; and
a control unit configured to control the exhaust control valve,
wherein when a measured value of the pressure measuring unit is equal to or less than a predetermined pressure, the control unit controls the exhaust control valve to increase the number of opening-closing operations per unit time more than when the measured value of the pressure measuring unit is higher than the predetermined pressure, and/or
when a measured value of the container temperature measuring unit is equal to or less than a predetermined container temperature, the control unit controls the exhaust control valve to increase the number of opening-closing operations per unit time more than when the measured value of the container temperature measuring unit is higher than the predetermined container temperature.

2. The fuel cell system according to claim 1, wherein the control unit controls the exhaust control valve to increase the number of opening-closing operations by shortening a valve-closing time of the exhaust control valve.

3. The fuel cell system according to claim 1, further comprising:
a fan for blowing heat generated in the fuel cell toward the hydrogen storage container; and
a cell temperature measuring unit for measuring a temperature of the fuel cell,
wherein the control unit is further configured to control the fan, and
the control unit activates the fan when a measured value of the cell temperature measuring unit is equal to or higher than a predetermined cell temperature, and
the control unit stops the fan when the measured value of the cell temperature measuring unit is less than the predetermined cell temperature.

4. The fuel cell system according to claim 2, further comprising:
a fan for blowing heat generated in the fuel cell toward the hydrogen storage container; and
a cell temperature measuring unit for measuring a temperature of the fuel cell,
wherein the control unit is further configured to control the fan, and
the control unit activates the fan when a measured value of the cell temperature measuring unit is equal to or higher than a predetermined cell temperature, and
the control unit stops the fan when the measured value of the cell temperature measuring unit is less than the predetermined cell temperature.
